(19) United States
(12) Patent Application Publication
(10) Pub. No.: US 2026/0287547 A1
(43) Pub. Date: Sep. 24, 2026

(54) ANALYSIS METHOD FOR CHELATE

(71) Applicant: KOREA ATOMIC ENERGY RESEARCH INSTITUTE, Daejeon (KR)

(72) Inventors: Jihye KIM, Daejeon (KR); Sunkyung JEONG, Daejeon (KR); Byungman KANG, Daejeon (KR)

(73) Assignee: KOREA ATOMIC ENERGY RESEARCH INSTITUTE, Daejeon (KR)

(21) Appl. No.: 19/574,872

(22) Filed: Mar. 23, 2026

(30) Foreign Application Priority Data
Mar. 28, 2025 (KR) 10-2025-0040018

(51) Int. Cl. G01N 27/447

(52) U.S. Cl. CPC G01N 27/44721; G01N 27/4473; G01N 27/44743; G01N 27/44747

(57) ABSTRACT

Provided is an analysis method for chelate. The analysis method comprises (S10) preparing a sample by mixing an analysis target material containing a chelate and a solvent, (S20) filling an interior of an open-ended capillary with a buffer running solution, (S30) injecting the sample such that the sample is concentrated in the interior of the open-ended capillary by using field amplified sample injection, and (S40) separating and detecting the chelate comprised in the sample concentrated in the interior of the open-ended capillary by using capillary electrophoresis.

### CROSS-REFERENCE TO RELATED APPLICATION

This application claims the benefit of priority to Korean Patent Application No. 10-2025-0040018, filed in the Korean Intellectual Property Office on Mar. 28, 2025, the entire contents of which are incorporated herein by reference.

### TECHNICAL FIELD

The present disclosure relates to an analysis method for chelate.

### BACKGROUND

Chelating agents are ligands capable of forming ring-shaped coordination complexes through coordination bonds with various metals, are used in decontamination systems of nuclear facilities, and are known to promote mobility of radionuclides during disposal of radioactive waste. For disposal of radioactive waste expected to contain such chelating agents, test results for a chemical name and a content of the chelating agent in the radioactive waste are essentially required.

Conventionally, chelate has been measured by using spectroscopy with a UV-Vis detector without a process of separating chelate by component; however, this method makes it difficult to simultaneously analyze a plurality of chelate species and has low analysis sensitivity, resulting in limitations in performing quantitative analysis and qualitative analysis of chelate by component. In addition, because analysis requires tens of milliliters of using the spectroscopy radioactive waste, additional generation of radioactive waste is inevitable.

As a solution to problems of the chelate analysis method using only the spectroscopy, capillary zone electrophoresis (CZE) has been utilized as an analysis method for analyzing a chemical name and a content of chelate by component. Capillary electrophoresis refers to a technique in which an electric field is applied in a capillary to induce migration of components in a solution, and since mobility of chelate varies depending on differences in a charge-to-size ratio of each component, the components pass through the capillary at different speeds, resulting in separation of components in the solution. In conventional capillary electrophoresis, as a preparation process for separating chelate by electrophoresis, a method of injecting an analysis target material, such as radioactive waste, into a capillary has been used, in which injection is performed while applying a predetermined pressure to one distal end of the capillary.

However, the injection method of the analysis target material using the pressure has an additional problem in that, when chelate is directly detected by using a UV-Vis detector, a free form chelate has no chromophore by itself, resulting in very low sensitivity, so that accurate quantitative analysis and qualitative analysis are difficult.

Accordingly, when analyzing a plurality of chelate species contained in an analysis target material such as radioactive waste, there is a need for an analysis method for chelate that enables simultaneous analysis in a short time while improving analysis sensitivity for chelate, thereby allowing accurate quantitative analysis and qualitative analysis for each chelate component.

### SUMMARY

The present disclosure has been made to solve the above-mentioned problems occurring in the prior art while advantages achieved by the prior art are maintained intact.

An aspect of the present disclosure provides an analysis method for chelate capable of solving the above-described problems.

That is, the present disclosure provides an analysis method for chelate that enables accurate quantitative analysis and qualitative analysis for chelate by injecting a sample such that the sample is concentrated in an interior of a capillary by using field amplified sample injection (FASI), resulting in improved analysis sensitivity for chelate contained in an analysis target material during separation and detection of chelate by electrophoresis.

The technical problems to be solved by the present disclosure are not limited to the aforementioned problems, and any other technical problems not mentioned herein will be clearly understood from the following description by those skilled in the art to which the present disclosure pertains.

To solve the above-described problems, the present disclosure provides an analysis method for chelate.

(1) An analysis method for chelate comprises (S10) preparing a sample by mixing an analysis target material containing a chelate and a solvent, (S20) filling an interior of an open-ended capillary with a buffer running solution, (S30) injecting the sample such that the sample is concentrated in the interior of the open-ended capillary by using field amplified sample injection, and (S40) separating and detecting the chelate comprised in the sample concentrated in the interior of the open-ended capillary by using capillary electrophoresis.

(2) in (1), the chelate comprises at least one selected from the group consisting of citric acid, ethylenediaminetetraacetic acid, nitrilotriacetic acid, diethylenetriaminepentaacetic acid, cyclohexanediaminetetraacetic acid, ethylene glycol-bis(2-aminoethyl ether)-N,N,N′,N′-tetraacetate, and hydroxyethyl ethylenediamine triacetate.

(3) in (1) or (2), the buffer running solution comprises at least one selected from the group consisting of a phosphate buffer, a borate buffer, an acetate buffer, a citrate buffer, an SDS buffer, and a tris buffer.

(4) in any one of (1) to (3), the buffer running solution has a pH of 3 or more and 14 or less.

(5) in any one of (1) to (4), the open-ended capillary has an inner surface that is surface-modified to be hydrophobic.

(6) in any one of (1) to (5), the open-ended capillary has an inner surface that is surface-modified with a polymer comprising at least one functional group selected from the group consisting of an ethylene group, an alcohol group, an ether group, an acrylamide group, and an amine group.

(7) in any one of (1) to (6), the open-ended capillary has an inner surface that is surface-modified with at least one compound selected from the group consisting of polyethylene glycol, polyvinyl alcohol, and polyacrylamide.

(8) in any one of (1) to (7), (S30) comprises (S31) immersing one distal end of the open-ended capillary in a container containing the sample, and (S32) applying a voltage to opposite distal ends of the open-ended capillary.

(9) in (8), (S32) is performed under a voltage condition of −30 kV or more and −1 kV or less.

(10) in (8) and (9), (S32) is performed for a time of 1 second or more and 300 seconds or less.

(11) in any one of (1) to (10), (S40) comprises (S41) separating the chelate comprised in the sample concentrated in the interior of the open-ended capillary by applying a voltage to opposite distal ends of the open-ended capillary, and (S42) detecting the separated chelate.

(12) in (11), (S41) is performed under a voltage condition of −30 kV or more and −1 kV or less.

(13) in (11) or (12), (S42) is performed by using at least one selected from the group consisting of a UV-Vis detector, a fluorescence detector, a mass spectrometer, an X-ray fluorescence analyzer, and an electrochemical detector.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic diagram for explaining an example of a method of filling an interior of an open-ended capillary with a buffer running solution, in operation S20, in an analysis method for chelate according to the present disclosure.

FIG. 2 is a schematic diagram for explaining an example of a method of immersing one distal end of an open-ended capillary in a container containing a sample, in operation S31, in an analysis method for chelate according to the present disclosure.

FIG. 3 is a schematic diagram for explaining an example of a method of applying a voltage to opposite distal ends of an open-ended capillary to concentratively inject the sample into an interior of the open-ended capillary, in operation S32, in an analysis method for chelate according to the present disclosure.

FIG. 4 is a schematic diagram for explaining an example of a method of separating chelate comprised in the sample concentratively injected into an interior of an open-ended capillary by using capillary zone electrophoresis (CZE), in operation (s41), in an analysis method for chelate according to the present disclosure.

FIG. 5 is a graph illustrating absorbance versus separation time for chelates separated and detected in embodiments and comparative examples.

### DETAILED DESCRIPTION

Hereinafter, the present disclosure will be described in more detail to help understanding of the present disclosure.

Terms or words used in the specification and claims should not be interpreted as being limited to ordinary or dictionary meanings, and should be interpreted as meanings and concepts that are consistent with the technical idea of this present disclosure based on the principle that the inventor may properly define the concepts of the terms to explain his or her invention in the best way.

The present disclosure provides an analysis method for chelate.

According to an embodiment of the present disclosure, the analysis method for chelate may comprise an operation (S10) of preparing a sample by mixing an analysis target material containing a chelate and a solvent; an operation (S20) of filling an interior of an open-ended capillary with a buffer running solution; an operation (S30) of injecting the sample such that the sample is concentrated in the interior of the open-ended capillary by using field amplified sample injection (FASI); and an operation (S40) of separating and detecting chelate comprised in the sample concentrated in the interior of the open-ended capillary by using capillary electrophoresis.

In conventional capillary zone electrophoresis (CZE) used for chelate analysis, when chelate is directly detected by using a UV-Vis detector, a free form chelate has no chromophore by itself, resulting in very low detection sensitivity, so that accurate quantitative analysis and qualitative analysis are difficult.

However, in an analysis method for chelate according to an embodiment of the present disclosure, by injecting a sample such that the sample is concentrated in an interior of an open-ended capillary by using field amplified sample injection (FASI), during separation and detection of chelate by capillary zone electrophoresis (CZE), chelate is concentratively injected at a high concentration in a specific region of the open-ended capillary, and the concentrated sample is moved by an electric field so that a plurality of chelate species are simultaneously separated, whereby analysis sensitivity for chelate may be improved, and accurate quantitative analysis and qualitative analysis of chelate may be achieved even for an analysis target material containing a trace amount of chelate. In addition, in the field amplified sample injection (FASI), because the sample may be concentratively injected even with a trace amount of the sample at a level of 1 μL to 2 μL, generation of radioactive waste may be reduced.

According to an embodiment of the present disclosure, the analysis method for chelate may comprise an operation (S10) of preparing a sample by mixing an analysis target material containing a chelate and a solvent.

Specifically, operation (S10) is an operation of manufacturing an analysis sample by mixing an analysis target material with a solvent, in order to perform quantitative analysis and qualitative analysis for each chelate component comprised in the analysis target material. More specifically, operation (S10) is an operation of preparing a sample for performing quantitative analysis and qualitative analysis for each chelate component by using capillary zone electrophoresis (CZE) on an analysis target material containing a chelate, and is an operation of preparing the sample by mixing the analysis target material and a solvent in a container.

According to an embodiment of the present disclosure, the analysis target material is a material that comprises a chelate, and refers to a material comprising a chelate complex or a free form chelate. The analysis target material is not particularly limited as long as it comprises a chelate, and is dissolved in a solvent so that separation and detection of the chelate by capillary zone electrophoresis (CZE) are possible. As a specific example, the analysis target material may be radioactive waste, industrial wastewater, or the like, and as a more specific example, the analysis target material may be radioactive waste. The radioactive waste is waste that comprises radioactive materials, and may generally exist in a solid state in terms of safety and ease of storage, but is not limited thereto.

According to an embodiment of the present disclosure, the chelate may comprise at least one selected from the group consisting of citric acid, ethylenediaminetetraacetic acid (EDTA), nitrilotriacetic acid (NTA), diethylenetriaminepentaacetic acid (DTPA), cyclohexanediaminetetraacetic acid (CDTA), ethylene glycol-bis(2-aminoethyl ether)-N,N,N′,N′-tetraacetate (EGTA), and hydroxyethyl ethylenediamine triacetate (HEDTA), and as a specific example, the chelate may comprise citric acid, ethylenediaminetetraacetic acid (EDTA), nitrilotriacetic acid (NTA), and diethylenetriaminepentaacetic acid (DTPA).

According to an embodiment of the present disclosure, the solvent is not particularly limited as long as it is capable of dissolving the analysis target material, and as a specific example, the solvent may comprise at least one selected from the group consisting of water, methanol, ethanol, a phosphate buffer, a borate buffer, an acetate buffer, a citrate buffer, an SDS buffer (sodium dodecyl sulfate buffer), and a tris buffer, and as a more specific example, the solvent may be water. When a buffer is comprised in the solvent, the buffer may be the same as the buffer running solution used in the present disclosure.

According to an embodiment of the present disclosure, the analysis method for chelate may comprise an operation (S20) of filling an interior of an open-ended capillary with a buffer running solution.

Specifically, operation (S20) is an operation of filling an interior of an open-ended capillary with a buffer running solution, in order to inject chelate comprised in a sample into the interior of the open-ended capillary and to create an environment in which the chelate may be separated and detected by using capillary zone electrophoresis (CZE).

Operation (S20) is not an operation that is temporally connected to operation (S10) described above, and each operation may be performed independently of each other. That is, operation (S10) and operation (S20) do not affect or depend on each other in implementation, may be performed independently of each other, and an order in which the operations are performed is not particularly limited. As a specific example, operation (S20) may be performed after operation (S10), may be performed before operation (S10), or may be performed simultaneously with operation (S10).

According to an embodiment of the present disclosure, operation (S20) may comprise an operation (S21) of cleaning the open-ended capillary; and an operation (S22) of immersing one distal end of the open-ended capillary in a container containing a buffer running solution.

According to an embodiment of the present disclosure, operation (S21) is an operation of removing impurities that may be present in an interior of an open-ended capillary, before filling the interior of the open-ended capillary with a buffer solution. A cleaning method in operation (S21) is not particularly limited, and as a specific example, the cleaning may be performed for a time of 1 minute or more and 10 minutes or less by spraying distilled water at a pressure of 1 psi or more and 100 psi or less.

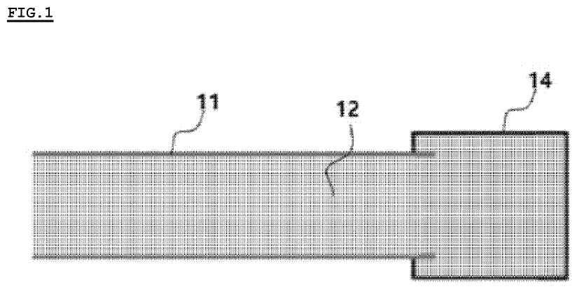

According to an embodiment of the present disclosure, operation (S22) is an operation for filling an interior of the cleaned open-ended capillary with a buffer running solution. As a specific example, as illustrated in FIG. 1, operation (S22) may be performed by immersing one distal end of the open-ended capillary 11 in a first container 14 containing a buffer running solution 12, and filling the interior of the open-ended capillary 11 with the buffer running solution 12 by using capillary action, in order to fill the interior of the open-ended capillary 11 with the buffer running solution 12.

According to an embodiment of the present disclosure, the buffer running solution may serve as a medium that allows chelate to migrate during an electrophoresis process. As a specific example, in the analysis method for chelate according to the present disclosure, when chelate is separated and detected by using capillary zone electrophoresis (CZE), a mobility of the chelate varies depending on differences in a charge-to-size ratio of the chelate comprised in the sample, so that, as an electric field application time elapses, the chelate in the buffer running solution may be separated by component.

According to an embodiment of the present disclosure, the buffer running solution may comprise at least one selected from the group consisting of a phosphate buffer, a borate buffer, an acetate buffer, a citrate buffer, an SDS buffer (sodium dodecyl sulfate buffer), and a tris buffer. As a specific example, the buffer running solution may comprise a phosphate buffer.

According to an embodiment of the present disclosure, the buffer running solution may have a pH of 3 or more and 14 or less. As a specific example, the buffer running solution may have a pH of 6 or more and 8 or less. Within this range, chelate comprised in the sample becomes anionic, resulting in improved separation efficiency for the chelate.

According to an embodiment of the present disclosure, electrical conductivity of the buffer running solution may be higher than electrical conductivity of the sample. This is to form a stronger electric field on a sample side than an electric field formed on a buffer running solution side, when field amplified sample injection (FASI) is used in operation (s30). That is, by using a property that electrical conductivity of a solution is inversely proportional to strength of an electric field when an identical voltage is applied, an electric field formed on the sample side is induced to be relatively stronger than an electric field formed on the buffer running solution side, so that chelate comprised in the sample moves rapidly by the strong electric field, resulting in improvement of concentration efficiency of the sample by field amplified sample injection (FASI).

According to an embodiment of the present disclosure, the open-ended capillary may be a tube-shaped conduit, in which one or two distal ends through which a substance may enter and exit are present. As a specific example, the open-ended capillary may have two distal ends. In addition, the open-ended capillary may be a fused silica capillary.

According to an embodiment of the present disclosure, the open-ended capillary may have an inner surface that is surface-modified to exhibit hydrophobicity. As a specific example, an inner surface of the open-ended capillary may be surface-modified with a polymer comprising a functional group, and the polymer may be chemically bonded to the inner surface of the open-ended capillary.

According to an embodiment of the present disclosure, the open-ended capillary may have an inner surface that is surface-modified with a polymer comprising at least one functional group selected from the group consisting of an ethylene group, an alcohol group, an ether group, an acrylamide group, and an amine group. As a specific example, the open-ended capillary may have an inner surface that is surface-modified with at least one compound selected from the group consisting of polyethylene glycol, polyvinyl alcohol, and polyacrylamide. An inner surface of a conventional open-ended capillary generally has a negative charge, and cations comprised in a buffer running solution are adsorbed near the negatively charged inner surface to form an electric double layer (EDL). However, when the inner surface of the open-ended capillary is surface-modified with the polymer, a magnitude of a negative charge of the inner surface of the open-ended capillary is weakened by the surface modification, resulting in a significant reduction in a magnitude of electroosmotic flow (EOF) formed by an electric field. As a result, while concentration efficiency of the sample by field amplified sample injection (FASI) may be improved, during separation and detection of anionic chelate by using capillary zone electrophoresis (CZE), the chelate may be clearly separated according to mobility of the chelate itself, resulting in improved separation performance of the chelate.

According to an embodiment of the present disclosure, the open-ended capillary may have an inner diameter of 1 μm or more and 100 μm or less, and as a specific example, may have an inner diameter of 30 μm or more and 70 μm or less.

According to an embodiment of the present disclosure, the open-ended capillary may have a length of 10 cm or more and 100 cm or less, and as a specific example, may have a length of 30 cm or more and 80 cm or less.

According to an embodiment of the present disclosure, the analysis method for chelate may comprise operation (s30) of injecting the sample such that the sample is concentrated in an interior of the open-ended capillary by using field amplified sample injection (FASI).

Field amplified sample injection (FASI) refers to a technique in which, by using an electrophoresis principle and a difference in electrical conductivity between a sample and a buffer running solution, an electric field is amplified during an injection process of the sample to continuously inject the sample, thereby injecting the sample such that the sample is concentrated in a specific region of the buffer running solution.

According to an embodiment of the present disclosure, operation (s30) may comprise operation (S31) of immersing one distal end of the open-ended capillary in a container containing the sample; and operation (S32) of applying a voltage to opposite distal ends of the open-ended capillary.

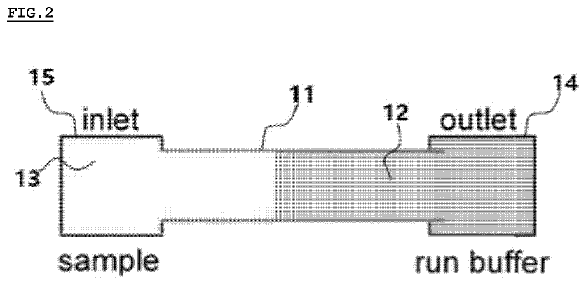

As a specific example, as illustrated in FIG. 2, operation (S31) may be performed through a process in which, with one distal end of the open-ended capillary 11 immersed in a first container 14 containing a buffer running solution 12, an opposite distal end of the open-ended capillary 11 is immersed in a second container 15 containing a sample 13. When a sufficient time elapses in a state in which an opposite distal end of the open-ended capillary is immersed in the second container, a boundary surface (not illustrated) between the buffer running solution 12 and the sample 13 may be formed in an interior of the open-ended capillary 11.

According to an embodiment of the present disclosure, operation (S32) may be an operation of inducing chelate comprised in the sample to be concentratively injected at a boundary surface between the buffer running solution and the sample, by applying a voltage to opposite distal ends of the open-ended capillary to form an electric field in an interior of the open-ended capillary.

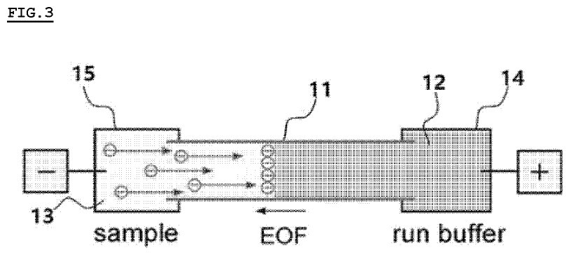

As a specific example, as illustrated in FIG. 3, operation (S32) is performed by applying a voltage to opposite distal ends of the open-ended capillary 11 to form an electric field in an interior of the open-ended capillary 11, in which a relatively low electric field is formed at one distal end of the open-ended capillary 11 where the buffer running solution 12 is present, and a relatively high electric field is formed at an opposite distal end of the open-ended capillary 11 where the sample 13 is present. This is because the sample 13 has lower electrical conductivity than the buffer running solution 12. Due to the relatively strong electric field formed in the sample 13, anionic chelate present in the sample 13 moves at a high speed toward a boundary surface between the sample 13 and the buffer running solution 12. However, as the chelate approaches the boundary surface between the sample 13 and the buffer running solution 12, strength of the electric field formed in a region in which the chelate is present decreases, resulting in a gradual decrease in a migration speed of the chelate. As a result, the chelate is concentrated while passing through the boundary surface between the sample 13 and the buffer running solution 12 at a low speed, and the chelate concentrated at the boundary surface moves toward the buffer running solution 12 side, so that the chelate is present in a concentrated state in a specific region of the buffer running solution.

By injecting the sample such that the sample is concentrated in an interior of the open-ended capillary by using field amplified sample injection (FASI) as described above, during separation and detection of chelate by capillary zone electrophoresis (CZE), the sample that is present at a high concentration in a specific region of a capillary injection portion is moved by an electric field so that a plurality of chelate species are simultaneously separated, whereby analysis sensitivity for chelate be improved, and accurate quantitative analysis and qualitative analysis of chelate may be achieved even for an analysis target material containing a trace amount of chelate. In addition, in the field amplified sample injection (FASI), because the sample may be concentratively injected even with a trace amount of the sample at a level of 1 μL to 2 μL, generation of radioactive waste may be reduced.

According to an embodiment of the present disclosure, operation (S32) may be performed under a voltage condition of −30 kV or more and −1 kV or less. As a specific example, operation (S32) may be performed under a voltage condition of −30 kV or more, −29 kV or more, −28 kV or more, −27 kV or more, −26 kV or more, −25 kV or more, −24 kV or more, −23 kV or more, −22 kV or more, −21 kV or more, −20 kV or more, −19 kV or more, −18 kV or more, −17 kV or more, −16 kV or more, −15 kV or more, −14 kV or more, −13 kV or more, −12 kV or more, −11 kV or more, or −10 kV or more to −1 kV or less, −2 kV or less, −3 kV or less, −4 kV or less, −5 kV or less, −6 kV or less, −7 kV or less, −8 kV or less, −9 kV or less, or −10 kV or less. Within this range, by appropriately controlling a migration speed of the chelate due to an electric field and a strength of electroosmotic flow (EOF) formed in a direction opposite to a migration direction of the chelate, concentration efficiency of the sample by field amplified sample injection (FASI) may be improved.

That the high-voltage condition has a negative (−) sign means that a reverse voltage is applied to opposite distal ends of the open-ended capillary. Specifically, as illustrated in FIG. 3, this means that a high voltage is supplied to one distal end of the open-ended capillary 11 where the buffer running solution 12 is present, and a relatively low voltage is supplied to an opposite distal end of the open-ended capillary 11 where the sample 13 is present. At this time, a magnitude of the voltage means a potential difference between opposite distal ends of the open-ended capillary.

According to an embodiment of the present disclosure, operation (S32) may be performed for a time of 1 second or more and 300 seconds or less. As a specific example, operation (S32) may be performed for a time of 1 second or more, 2 seconds or more, 3 seconds or more, 4 seconds or more, 5 seconds or more, 6 seconds or more, 7 seconds or more, 8 seconds or more, 9 seconds or more, 10 seconds or more, 11 seconds or more, 12 seconds or more, 13 seconds or more, 14 seconds or more, 15 seconds or more, 16 seconds or more, 17 seconds or more, 18 seconds or more, 19 seconds or more, or 20 seconds or more, and may also be performed for a time of 300 seconds or less, 280 seconds or less, 260 seconds or less, 240 seconds or less, 220 seconds or less, 200 seconds or less, 180 seconds or less, 160 seconds or less, 140 seconds or less, 120 seconds or less, 100 seconds or less, 80 seconds or less, 60 seconds or less, 40 seconds or less, or 20 seconds or less. Within this range, as a result that the sample comprising chelate is concentratively injected for a sufficient time, analysis sensitivity for chelate may be improved during separation and detection of chelate by capillary zone electrophoresis (CZE).

According to an embodiment of the present disclosure, the analysis method for chelate may comprise an operation (s40) of separating and detecting chelate comprised in the sample concentrated in an interior of the open-ended capillary by using capillary zone electrophoresis (CZE). Here, capillary zone electrophoresis refers to a technique in which an electric field is applied in a capillary to induce migration of components in a solution, and since mobility of chelate varies depending on differences in a charge-to-size ratio of each component, the components pass through the capillary at different speeds, resulting in separation of components in the solution.

According to an embodiment of the present disclosure, as a specific example, operation (s40) may comprise an operation (s41) of separating chelate comprised in the sample concentrated in the interior of the open-ended capillary by applying a voltage to opposite distal ends of the open-ended capillary; and an operation (S42) of detecting the separated chelate.

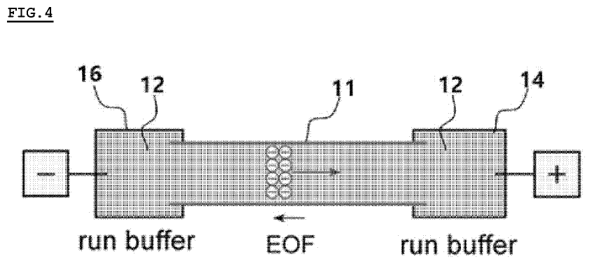

According to an embodiment of the present disclosure, operation (s41) is a process for separating chelate comprised in the sample concentratively injected into an interior of the open-ended capillary by using capillary zone electrophoresis (CZE). As a specific example, as illustrated in FIG. 4, after replacing the first container 14 in which one distal end of the open-ended capillary 11 is immersed with a third container 16 containing the buffer running solution 12 and immersing the one distal end therein, a voltage is applied to opposite distal ends of the open-ended capillary 11 to form an electric field in an interior of the open-ended capillary 11. As a result that chelate comprised in the sample concentratively injected into an interior of the open-ended capillary 11 receives an electrical force by the formed electric field, anionic chelate moves toward a buffer running solution 12 side where a positive (+) electrode is present. At this time, since the chelate has differences in a charge-to-size ratio depending on components, a migration speed varies depending on a chelate component. Due to the difference in migration speed, as a voltage application time elapses, the chelate is positioned in different regions depending on components, and the chelate comprised in the sample is separated by component.

According to an embodiment of the present disclosure, operation (s41) may be performed under a voltage condition of −30 kV or more and −1 kV or less. As a specific example, operation (s41) may be performed under a voltage condition of −30 kV or more, −29 kV or more, −28 kV or more, −27 kV or more, −26 kV or more, −25 kV or more, −24 kV or more, −23 kV or more, −22 kV or more, −21 kV or more, −20 kV or more, −19 kV or more, −18 kV or more, −17 kV or more, −16 kV or more, or −15 kV or more to −1 kV or less, −2 kV or less, −3 kV or less, −4 kV or less, −5 kV or less, −6 kV or less, −7 kV or less, −8 kV or less, −9 kV or less, −10 kV or less, −11 kV or less, −12 kV or less, −13 kV or less, −14 kV or less, or −15 kV or less. Within this range, by appropriately controlling a migration speed of the chelate due to an electric field and a strength of electroosmotic flow (EOF) formed in a direction opposite to a migration direction of the chelate, separation efficiency of the chelate by capillary zone electrophoresis (CZE) may be improved.

That the voltage condition has a negative (−) sign means that a reverse voltage is applied to opposite distal ends of the open-ended capillary. Specifically, as illustrated in FIG. 4, this means that a high voltage is supplied to one distal end of the open-ended capillary 11 where the buffer running solution 12 is present, and a relatively low voltage is supplied to an opposite distal end of the open-ended capillary 11 where the sample 13 is present. At this time, a magnitude of the voltage means a potential difference between opposite distal ends of the open-ended capillary.

According to an embodiment of the present disclosure, operation (s41) may be performed under a temperature condition of 10° C. or more and 40° C. or less. As a specific example, operation (s41) may be performed under a temperature condition of 10° C. or more, 15° C. or more, 20° C. or more, or 25° C. or more to 40° C. or less, 35° C. or less, 30° C. or less, or 25° C. or less.

According to an embodiment of the present disclosure, operation (s41) may be performed for a time of 10 minutes or more and 25 minutes or less. As a specific example, operation (s41) may be performed for a time of 10 minutes or more, 11 minutes or more, 12 minutes or more, 13 minutes or more, 14 minutes or more, or 15 minutes or more to 25 minutes or less, 24 minutes or less, 23 minutes or less, 22 minutes or less, 21 minutes or less, or 20 minutes or less. Within this range, as a result that chelate comprised in the concentrated sample is separated for a sufficient time, separation performance of the chelate may be improved.

According to an embodiment of the present disclosure, operation (s42) is an operation of performing quantitative analysis and qualitative analysis for each component of the separated chelate by using a detector, with respect to the chelate separated in the preceding operation (s41).

According to an embodiment of the present disclosure, operation (s42) may be performed, as a specific example, by using at least one selected from the group consisting of a UV-Vis detector, a fluorescence detector, a mass spectrometer, an X-ray fluorescence analyzer, and an electrochemical detector, and as a more specific example, the detector may be at least one selected from the group consisting of a UV-Vis detector and a mass spectrometer.

Hereinafter, the present disclosure will be described in more detail with reference to embodiments. However, the following embodiments are provided only for illustrating the present disclosure, and the scope of the present disclosure is not limited thereto.

### Manufacturing Example

### Manufacturing Example 1: Manufacturing of Analysis Target Material

An analysis target material in which molar concentrations of citric acid, EDTA, NTA, and DTPA were each 5 mM was prepared by mixing, in a 15 mL centrifuge tube, 1 mL of a 0.05 M citric acid standard solution, 1 of a mL 0.05 M ethylenediaminetetraacetic acid (EDTA) standard solution, 1 ml of a 0.05 M nitrilotriacetic acid (NTA) standard solution, 1 mL of a 0.05 M diethylenetriaminepentaacetic acid (DTPA) standard solution, and 6 mL of distilled water.

### Manufacturing Example 2: Preparation of Open-ended Capillary Filled with Buffer Running Solution

An open-ended capillary (Agilent Technologies) having an inner surface coated with DB-Wax comprising polyethylene glycol (PEG) (inner diameter: 50 μm, total length: 68 cm, effective length: 58 cm) was prepared, and a 50 mM sodium phosphate aqueous solution having a pH of 7.0 was prepared as a buffer running solution.

Next, the open-ended capillary was first cleaned with distilled water at a pressure of 60 psi for 5 minutes, and then secondarily cleaned with the buffer running solution at a pressure of 60 psi for 5 minutes. After completion of the second cleaning, one distal end of the open-ended capillary was immersed in a container containing the buffer running solution, and an interior of the open-ended capillary was filled with the buffer running solution by using capillary action.

### Embodiments and Comparative Examples

### Embodiments

A sample in which molar concentrations of each chelate were 0.05 mM was prepared by mixing 0.1 mL of the analysis target material prepared in Manufacturing Example 1 with 9.9 mL of distilled water. A sample in which final molar concentrations of each chelate were 0.005 mM was prepared by mixing 1 mL of the sample in which molar concentrations of each chelate were 0.05 mM with 9 mL of distilled water.

Thereafter, by using a capillary electrophoresis apparatus (SCIEX, PA800 Plus), with one distal end of the open-ended capillary filled with the buffer running solution prepared in Manufacturing Example 2 immersed in a first container containing the buffer running solution prepared in Manufacturing Example 2, an opposite distal end of the open-ended capillary was immersed in a second container containing the sample. Thereafter, by applying field amplified sample injection (FASI), a reverse voltage of −10 kV was applied for 20 seconds to concentratively inject the sample into an interior of the open-ended capillary. At this time, application of the reverse voltage of −10 kV was performed in a manner in which a positive voltage was applied to an electrode on a side of one distal end of the open-ended capillary immersed in the first container, and a negative voltage was applied to an electrode on a side of an opposite distal end of the open-ended capillary immersed in the second container, while adjusting a potential difference between the two electrodes to be 10 kV.

Next, the second container containing the sample was replaced with a third container containing the buffer running solution prepared in Manufacturing Example 2, and the opposite distal end of the open-ended capillary was immersed in the third container. Thereafter, by using capillary zone electrophoresis (CZE), a reverse voltage of −15 kV was applied to opposite distal ends of the open-ended capillary for 20 minutes under a temperature condition of 25° C., thereby separating four chelate species comprised in the sample by component. At this time, application of the reverse voltage of −15 kV was performed in a manner in which a positive voltage was applied to an electrode on a side of one distal end of the open-ended capillary immersed in the first container, and a negative voltage was applied to an electrode on a side of an opposite distal end of the open-ended capillary immersed in the third container, while adjusting a potential difference between the two electrodes to be 15 kV.

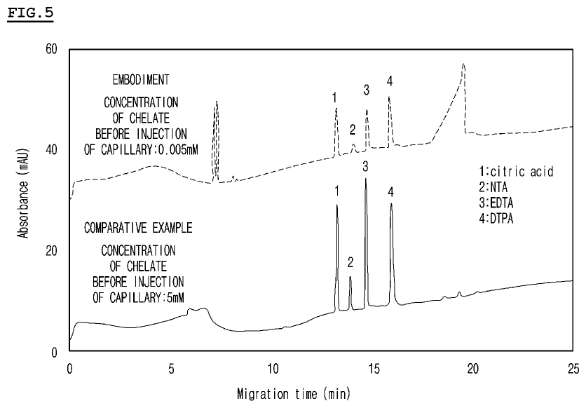

During the separation process, by using a modular UV-Vis detector of a capillary electrophoresis apparatus (SCIEX, PA800 Plus), absorbance versus separation time for the chelates separated by the above method was measured at a wavelength of 193 nm, and results thereof are illustrated in FIG. 5.

Absorbance measurement method versus separation time: after removing a polyimide coating at a position located 10 cm away from an opposite distal end of the open-ended capillary immersed in the third container to form a transparent window having a size of 2 mm×2 mm, absorbance versus migration time of chelate passing through the position was measured at the position by using a modular UV-Vis detector of a capillary electrophoresis apparatus (SCIEX, PA800 Plus).

### Comparative Example

A sample was prepared by placing 0.2 mL of the analysis target material manufactured in Manufacturing Example 1 in a vial.

Thereafter, by using a capillary electrophoresis apparatus (SCIEX, PA800 Plus), with one distal end of the open-ended capillary filled with the buffer running solution prepared in Manufacturing Example 2 immersed in a fourth container containing the buffer running solution prepared in Manufacturing Example 2, an opposite distal end of the open-ended capillary was immersed in a vial containing the sample, and the sample was injected into an interior of the open-ended capillary by applying a pressure of 0.5 psi to the vial for 5 seconds.

Next, the vial containing the sample was replaced with the third container containing the buffer running solution prepared in Manufacturing Example 2, and the opposite distal end of the open-ended capillary was immersed in the third container. Thereafter, by using capillary zone electrophoresis (CZE), a reverse voltage of −15 kV was applied to opposite distal ends of the open-ended capillary for 20 minutes under a temperature condition of 25° C., thereby separating four chelate species comprised in the sample by component. At this time, application of the reverse voltage of −15 kV was performed in a manner in which a positive voltage was applied to an electrode on a side of one distal end of the open-ended capillary immersed in the first container, and a negative voltage was applied to an electrode on a side of an opposite distal end of the open-ended capillary immersed in the third container, while adjusting a potential difference between the two electrodes to be 15 kV.

During the separation process, by using a modular UV-Vis detector of a capillary electrophoresis apparatus (SCIEX, PA800 Plus), absorbance versus separation time for the chelates separated by the above method was measured at a wavelength of 193 nm, and results thereof are illustrated in FIG. 5.

Absorbance measurement method versus separation time: after removing a polyimide coating at a position located 10 cm away from an opposite distal end of the open-ended capillary immersed in the third container to form a transparent window having a size of 2 mm×2 mm, absorbance versus migration time of chelate passing through the position was measured at the position by using a modular UV-Vis detector of a capillary electrophoresis apparatus (SCIEX, PA800 Plus).

### Experimental Example 1: Evaluation of Analysis Sensitivity and Concentration Efficiency of Chelate According to Sample Injection Method

Measurement results for absorbance versus separation time of chelate obtained in Embodiments and Comparative Examples can be identified in FIG. 5. Absorbance for embodiments and Comparative Examples was measured while separating and detecting chelate after injecting samples in which molar concentrations of citric acid, EDTA, NTA, and DTPA were each 0.005 mM and 5 mM.

In addition, an enrichment factor (EF) calculated from Equation 1 below was calculated by using intensities of absorbance peaks for chelate obtained in FIG. 5, and results thereof are shown in Table 1 below. Here, the enrichment factor refers to a relative ratio of analysis sensitivity for chelate according to a difference in a sample injection method between embodiments and Comparative Examples.

$$Enrichment factor ( EF ) = \frac{{H}_{FASI}}{{H}_{CZE}} \times \frac{{C}_{CZE}}{{C}_{FASI}} \qquad [ Equation 1 ]$$

wherein in Equation 1,
C CZE is a concentration (M) of the sample concentratively injected into an interior of the open-ended capillary by a sample injection method according to a Comparative Example,
C_FASI is a concentration (M) of the sample concentratively injected into an interior of the open-ended capillary by a sample injection method according to an embodiment,
H_CZE is an intensity (mAU) of an absorbance peak for chelate separated and detected in a Comparative Example, and
H_FASI is an intensity (mAU) of an absorbance peak for chelate separated and detected in an embodiment.

TABLE 1

| chelate | citric acid | NTA | EDTA | DTPA |
|---|---|---|---|---|
| Enrichment | 450 | 310 | 320 | 520 |
| factor (−) | | | | |

Referring to results of FIG. 5, in an embodiment in which a sample was concentratively injected into an open-ended capillary by using field amplified sample injection (FASI), even though a concentration of the sample before injection was manufactured to be 1,000 times lower than that of a Comparative Example, it was identified that intensities of absorbance peaks were stronger than those of the Comparative Example in which the sample was injected into the open-ended capillary by using pressure. From this, it could be inferred that, in the sample injection method using field amplified sample injection according to the embodiment, while maintaining an overall concentration of the sample at a low level in the interior of the open-ended capillary, chelate is intensively concentrated, so that, during electrophoresis, the chelate is separated in a concentrated state for each component, resulting in high absorbance peaks for each chelate component.

In addition, referring to results of Table 1, it was identified that enrichment factor (EF) values calculated from Equation 1 were 450, 310, 320, and 520 for citric acid, NTA, EDTA, and DTPA, respectively. From this, it was identified that, in the embodiment, analysis sensitivity for chelate was improved by approximately 300 times to 500 times as compared with the Comparative Example.

### Experimental Example 2: Identification of Detection Limit and Quantification Limit of Chelate Analysis Method According to Embodiment

For four chelate species separated and detected by the analysis method for chelate according to the embodiment, a limit of detection (LOD) was measured based on 3, and, after five measurements, an arithmetic mean value of each measurement was calculated, and results thereof are shown in Table 2 below. Here, s refers to a standard deviation of a background noise signal identified by materials other than chelate.

TABLE 2

| chelate | citric acid | NTA | EDTA | DTPA |
|---|---|---|---|---|
| limit of | 18 | 81 | 20 | 17 |
| detection (nM) | | | | |
| limit of | 4 | 24 | 4 | 7 |
| detection (ppb) | | | | |

Referring to results of Table 2, it was identified that the analysis method for chelate according to the embodiment has a low limit of detection of 25 ppb (100 nM) or less for four chelate species separated and detected, through which it can be confirmed that analysis sensitivity for chelate is significantly improved in the analysis method for chelate according to the embodiment. From this, it is expected that the analysis method for chelate according to the present disclosure, having a low limit of detection, enables accurate quantitative analysis and qualitative analysis for each chelate component.

The analysis method for chelate according to the present disclosure improves analysis sensitivity for chelate contained in an analysis target material during separation and detection of chelate by electrophoresis, so that chelate contained in the analysis target material can be simultaneously analyzed with only a small amount of radioactive waste, and accurate quantitative analysis and qualitative analysis are possible not only for chelate complexes but also for free form chelate having no chromophore.

In addition, the analysis method for chelate according to the present disclosure can separate and detect chelate contained in an analysis target material with only a small amount of radioactive waste, thereby reducing generation of radioactive waste.

What is claimed is:

1. An analysis method for chelate comprising:
(S10) preparing a sample by mixing an analysis target material containing a chelate and a solvent;
(S20) filling an interior of an open-ended capillary with a buffer running solution;
(S30) injecting the sample such that the sample is concentrated in the interior of the open-ended capillary by using field amplified sample injection; and
(S40) separating and detecting the chelate comprised in the sample concentrated in the interior of the open-ended capillary by using capillary electrophoresis.

2. The analysis method of claim 1, wherein the chelate comprises at least one selected from the group consisting of citric acid, ethylenediaminetetraacetic acid, nitrilotriacetic acid, diethylenetriaminepentaacetic acid, cyclohexanediaminetetraacetic acid, ethylene glycol-bis(2-aminoethyl ether)-N,N,N′,N′-tetraacetate, and hydroxyethyl ethylenediamine triacetate.

3. The analysis method of claim 1, wherein the buffer running solution comprises at least one selected from the group consisting of a phosphate buffer, a borate buffer, an acetate buffer, a citrate buffer, an SDS buffer, and a tris buffer.

4. The analysis method of claim 1, wherein the buffer running solution has a pH of 3 or more and 14 or less.

5. The analysis method of claim 1, wherein the open-ended capillary has an inner surface that is surface-modified to be hydrophobic.

6. The analysis method of claim 1, wherein the open-ended capillary has an inner surface that is surface-modified with a polymer comprising at least one functional group selected from the group consisting of an ethylene group, an alcohol group, an ether group, an acrylamide group, and an amine group.

7. The analysis method of claim 1, wherein the open-ended capillary has an inner surface that is surface-modified with at least one compound selected from the group consisting of polyethylene glycol, polyvinyl alcohol, and polyacrylamide.

8. The analysis method of claim 1, wherein (S30) comprises:
(S31) immersing one distal end of the open-ended capillary in a container containing the sample; and
(S32) applying a voltage to opposite distal ends of the open-ended capillary.

9. The analysis method of claim 8, wherein (S32) is performed under a voltage condition of −30 kV or more and −1 kV or less.

10. The analysis method of claim 8, wherein (S32) is performed for a time of 1 second or more and 300 seconds or less.

11. The analysis method of wherein (S40) comprises:
(S41) separating the chelate comprised in the sample concentrated in the interior of the open-ended capillary by applying a voltage to opposite distal ends of the open-ended capillary; and
(S42) detecting the separated chelate.

12. The analysis method of claim 11, wherein (S41) is performed under a voltage condition of −30 kV or more and −1 kV or less.

13. The analysis method of claim 11, wherein (S42) is performed by using at least one selected from the group consisting of a UV-Vis detector, a fluorescence detector, a mass spectrometer, an X-ray fluorescence analyzer, and an electrochemical detector.
